(19) United States
(12) Patent Application Publication
(10) Pub. No.: US 2014/0333429 A1
(43) Pub. Date: Nov. 13, 2014

(54) FRONT AND SIDE VEHICLE BRAKE INDICATOR SYSTEM

(71) Applicants: PABLITO ARRIOLA DE LA ROSA, SAN DIEGO, CA (US); DARLENE HUANG SAMMON, STUDIO CITY, CA (US); JESSE HUANG DE LA ROSA, SAN DIEGO, CA (US); MICHAEL HUANG DE LA ROSA, SAN DIEGO, CA (US)

(72) Inventors: PABLITO ARRIOLA DE LA ROSA, SAN DIEGO, CA (US); DARLENE HUANG SAMMON, STUDIO CITY, CA (US); JESSE HUANG DE LA ROSA, SAN DIEGO, CA (US); MICHAEL HUANG DE LA ROSA, SAN DIEGO, CA (US)

(21) Appl. No.: 14/272,337

(22) Filed: May 7, 2014

Related U.S. Application Data
(60) Provisional application No. 61/855,245, filed on May 13, 2013.

(51) Int. Cl. B60Q 1/44

(52) U.S. Cl. CPC B60Q 1/44
USPC 340/479

(57) ABSTRACT

Some embodiments of the present disclosure include a front and side viewable brake indicator system for a vehicle. The brake indicator system may include a pair of front mounted brake lights mounted on a vehicle, the first front mounted brake light mounted to a position proximate to a passenger side front corner of the vehicle, and the second front mounted brake light mounted to a position proximate to a driver side front corner of the vehicle. In some embodiments, the system also includes a top mounted brake light mounted on an exterior surface of a roof of the vehicle. Each of the brake lights may be configured to be viewed at a position in front of and to a side of the vehicle and may be configured to illuminate when a driver presses on a brake pedal in the vehicle.

### RELATED APPLICATION

This application claims priority to provisional patent application U.S. Ser. No. 61/855,245 filed on May 13, 2013, the entire contents of which is herein incorporated by reference.

### BACKGROUND

The embodiments herein relate generally to automobile accessories, and more particularly, to brake indicators for a vehicle that may be seen from the front and side of the vehicle.

Conventionally, vehicles only have brake indicators, such as red brake lights, on the rear of the vehicle. As a result, the brake lights can only be seen from a position behind the vehicle and a driver, pedestrian, or other person located to the side or in front of a vehicle is unaware whether the vehicle is braking. Because a person in front or to the side of a vehicle is unaware if the vehicle is braking, safety can be an issue. For example, when trying to switch lanes on a highway, a driver of a first car may be unsure whether a second car is going to let the driver switch lanes and pull in front of the second car. If the second car is not intending to let the driver into the lane and the driver moves over anyways, this could result in a collision. Similar circumstances may arise when a driver is trying to pull out of one road onto another road. Additionally, pedestrians or cyclists trying to cross the road in front of a vehicle do not know for sure if the approaching vehicle is braking.

Therefore, what is needed is an exterior brake indicator viewable at positions in front of and to the side of a vehicle.

### SUMMARY

Some embodiments of the present disclosure include a front and side viewable brake indicator system for a vehicle. The brake indicator system may include a pair of front mounted brake lights mounted on a vehicle, the first front mounted brake light mounted to a position proximate to a passenger side front corner of the vehicle, and the second front mounted brake light mounted to a position proximate to a driver side front corner of the vehicle. In some embodiments, the system also includes a top mounted brake light mounted on an exterior surface of a roof of the vehicle. Each of the brake lights may be configured to be viewed at a position in front of and to a side of the vehicle and may be configured to illuminate when a driver presses on a brake pedal in the vehicle.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiments of the present invention.

FIG. 2 is a detailed perspective view of one embodiment of the present invention illustrating activation of the front and side viewable brake indicator.

FIG. 3 is a perspective view of one embodiment of the present invention.

FIG. 4 is a schematic view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a front and side brake indicator on a vehicle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Front Mounted Brake Indicator

2. Top Mounted Brake Indicator

The various elements of the front and side break indicator for alerting a person in front of or to the side of the vehicle that a driver of the vehicle is braking of the present disclosure may be related in the following exemplary fashion. It is not intended to limit the scope or nature of the relationships between the various elements and the following examples are presented as illustrative examples only.

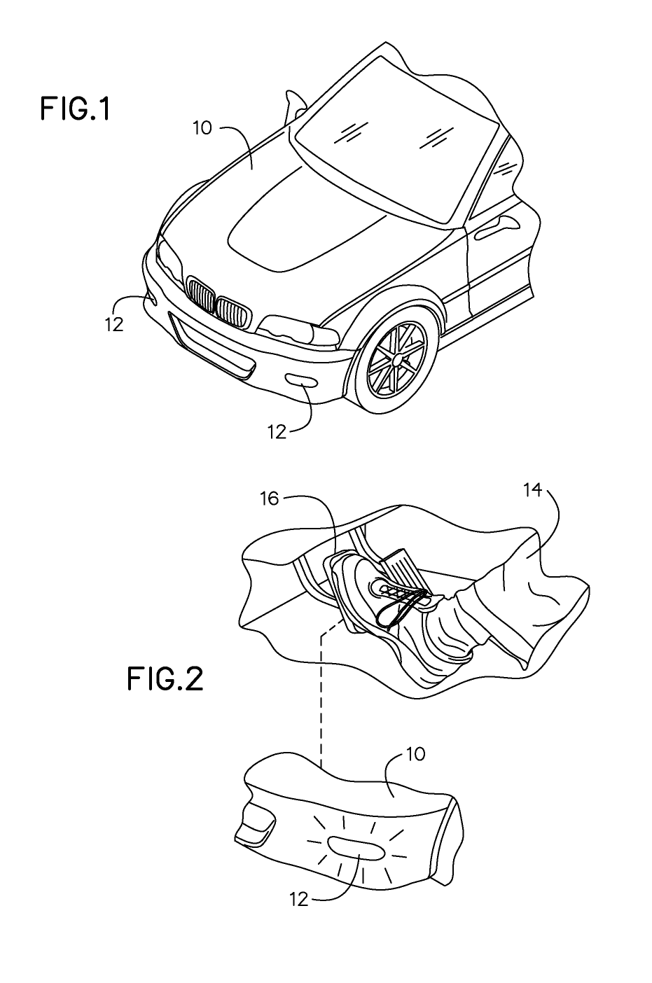

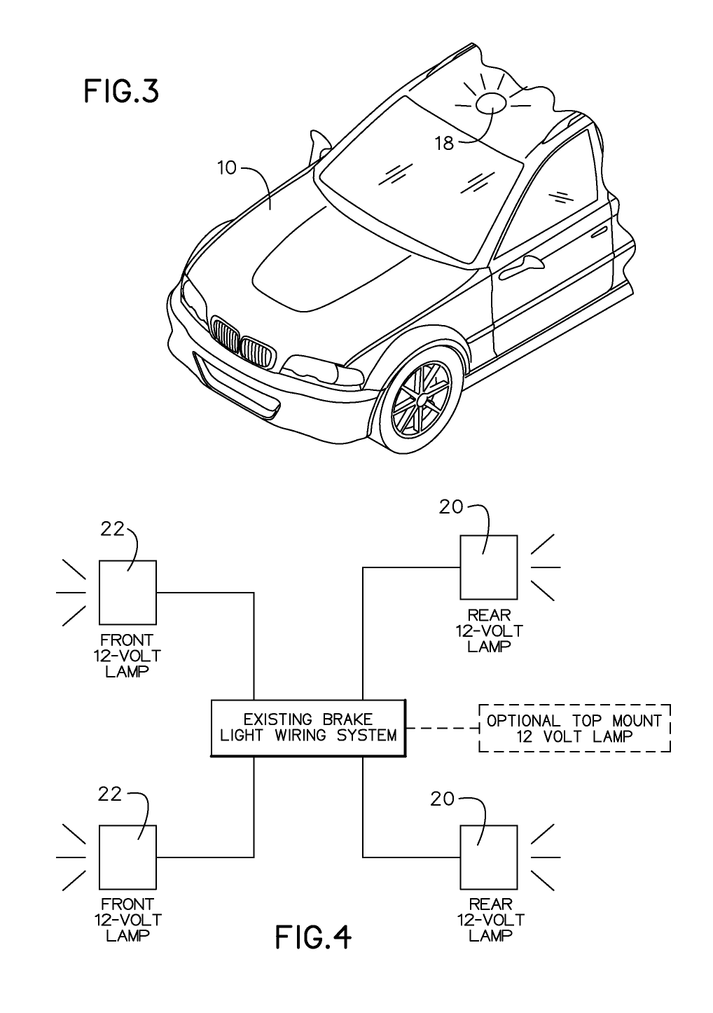

By way of example, and referring to FIGS. 1-4, some embodiments of the front and side brake indicator system of the present disclosure comprise a brake indicator positioned on a vehicle 10 such that the brake indicator is configured to be viewed at a position in front of and to the side of the vehicle 10. In some embodiments, the brake indicator may comprise at least one front mounted brake indictor 12 positioned proximate to the bumper of the vehicle and extending form a position on the front of a vehicle 10 to a position on the side of the vehicle 10, as shown in FIG. 1. In other embodiments, the brake indicator may comprise a top mounted brake indicator 18 mounted to the exterior of the roof of a vehicle 10, as shown in FIG. 3. Yet in further embodiments, a vehicle 10 may comprise both the front mounted brake indicator 12 and the top mounted brake indicator 18.

In some embodiments, the brake indicators 12, 18 may be configured to produce an alert when a user 14 presses a brake pedal 16 in the vehicle 10. For example, the brake indicators 12, 18 may comprise a brake light that illuminates when a user 14 steps on a brake pedal 16, as shown in FIG. 2. In such instances, the front mounted brake indicators 12 may comprise a light built into a portion of the car proximate to the front bumper. For example, a first front mounted brake indicator 12 may be mounted proximate to a passenger side front corner of the vehicle, while a second front mounted brake indicator 12 may be mounted proximate to a driver side front corner of the vehicle. In some embodiments, the light may be a red light. Alternatively, the light may be an uncolored light bulb positioned in a brake light housing, wherein the brake light housing comprises a transparent red window. Similarly, the top mounted brake indicator 18 may comprise a light attached to an exterior surface of the roof of a vehicle 10, wherein the light may be either a red light bulb or an uncolored light bulb positioned within a red transparent housing. As a result, the brake indicators 12, 18 may glow red when a user 14 presses on the brake pedal 16. While the brake indicators may glow red because society is accustomed to red lights indicating that a vehicle is braking, the brake indicators are not limited to glowing red in color and may glow other colors or otherwise alert a person outside of the vehicle that the vehicle is braking, as desired.

As shown in FIG. 4, the brake indicators 12, 18 may be wired into the existing brake light wiring system, such that the conventional back brake lights and the brake indicators 12, 18 are wired into the same system, which allows power to flow to the brake indicators 12, 18 when a user 14 presses the brake pedal 16. For example, as shown in FIG. 4, the front mounted brake indicators 12 may comprise front 12-volt lamps 22, the conventional brake lights may comprise rear 12-volt lamps 20, and the top mounted brake indicator 18 may comprise a top mount 12-volt lamp.

In some embodiments, the front mounted brake indicators 12 may be built into the existing headlight housing. Alternatively, the front mounted brake indicators 12 may have a housing separate from the existing headlight housing, as shown in FIG. 1. In embodiments, the top mounted brake indicator 18 may be substantially dome shaped, as shown in FIG. 3. Alternatively, the top mounted brake indicator 18 may have any other desired shape, such as square, rectangular, triangular, and ovular. So long as the brake indicators 12, 18 may be viewed from a position in front of or to the side of the vehicle 10, the brake indicators 12, 18 may have any size or shape.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A front and side viewable brake indicator system for a vehicle, the brake indicator system comprising:
at least one brake indicator positioned on a vehicle,
wherein:
the brake indicator is configured to be viewed at a position in front of and to the side of the vehicle; and
the brake indicator is operatively connected to a brake pedal in the vehicle; and
the brake indicator is configured to produce an alert when a driver presses the brake pedal in the vehicle.

2. The brake indicator system of claim 1, wherein the brake indicator is a brake light mounted to the vehicle.

3. The brake indicator system of claim 2, wherein:
the vehicle comprises two headlights on a front portion of the vehicle;
the brake indicator system comprises two brake indicators, a first brake light being mounted proximate to a first headlight and a second brake light being mounted proximate to the second headlight; and
each of the two brake lights curves around from a front surface of the vehicle to a side surface of the vehicle.

4. The brake indicator system of claim 3, further comprising an additional brake indicator mounted to an exterior surface of a roof of the vehicle, the additional brake indicator configured to produce an alert when the driver presses on the brake pedal.

5. The brake indicator system of claim 2, wherein:
the brake light comprises a 12 volt lamp positioned within a brake light housing, the brake light housing comprising a transparent, red window; and
the brake light housing is configured to glow red when the driver presses on the brake pedal.

6. The brake indicator system of claim 2, wherein each of the two brake indicators are built into a housing that houses the headlights.

7. A front and side viewable brake indicator system for a vehicle, the brake indicator system comprising:
a pair of front mounted brake lights mounted on a vehicle, the first front mounted brake light mounted to a position proximate to a passenger side front corner of the vehicle, and the second front mounted brake light mounted to a position proximate to a driver side front corner of the vehicle,
wherein:
each of the brake lights is configured to be viewed at a position in front of and to a side of the vehicle;
each of the brake lights is operatively connected to a brake pedal in the vehicle; and
each of the brake lights is configured to illuminate when a driver presses on the brake pedal.

8. The brake indicator system of claim 7, further comprising a top mounted brake light mounted on an exterior surface of a roof of the vehicle, the top mounted brake light configured to illuminate when the driver presses the brake pedal.

9. The brake indicator system of claim 7, wherein the brake lights each comprise a 12 volt lamp situated within a transparent, red housing, the brake lights configured to produce a red glow when the driver presses on the brake pedal.

10. The brake indicator system of claim 7, wherein:
the vehicle comprises a pair of headlights comprising a headlight housing; and
each of the front mounted brake lights is situated within the respective headlight housing.
